(19) United States
(12) Patent Application Publication
(10) Pub. No.: US 2005/0015280 A1
(43) Pub. Date: Jan. 20, 2005

(54) Health care eligibility verification and settlement systems and methods

(75) Inventors: Judi Gabel, Omaha, NE (US); Robyn Bartlett, Omaha, NE (US); Beverly Kennedy, Greenwood Village, CO (US); Bradley Winking, Omaha, NE (US); George Nauman, Omaha, NE (US); Judy Turek, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/846,947

(22) Filed: May 13, 2004

Related U.S. Application Data
(63) Continuation-in-part of application No. 10/675,929, filed on Sep. 29, 2003.
(63) Continuation-in-part of application No. 10/460,741, filed on Jun. 11, 2003.
(60) Provisional application No. 60/515,918, filed on Oct. 29, 2003.
(60) Provisional application No. 60/417,205, filed on Oct. 8, 2002.
(60) Provisional application No. 60/388,047, filed on Jun. 11, 2002.

(51) Int. Cl. G06F 17/60

(52) U.S. Cl. 705/2

(57) ABSTRACT

A method of verifying health insurance coverage eligibility for a patient includes receiving at a host computer system a message from a provider. The message includes a request for an eligibility and coverage information packet. The message identifies at least the patient and the provider. The method also includes using at least a portion of the information in the request to locate a payer associated with the patient and sending a message to a computing system of the payer. The message comprises a request to return to the host computer system the eligibility and coverage information packet. The method also includes receiving the eligibility and coverage information packet from the computing system of the payer and sending the packet to the provider.

### CROSS-REFERENCES TO RELATED APPLICATIONS

This application is a non-provisional of and claims the benefit of U.S. Patent Application No. 60/515918 (attorney Docket No. 020375-045400), entitled “HEALTH CARE ELIGIBILITY VERIFICATION SYSTEMS AND METHODS,” filed on Oct. 29, 2003, by Judi Gabel, et al., the entire disclosure of which is herein incorporated by reference for all purposes. This application is a continuation-in-part of co-pending, commonly assigned U.S. patent application Ser. No. 10/675929 (Attorney Docket No. 020375-032410), entitled “SYSTEMS AND METHODS FOR VERIFYING MEDICAL INSURANCE COVERAGE,” filed on Sep. 29, 2003, by Charles Whitaker, et al., and of co-pending, commonly assigned U.S. patent application Ser. No. 10/460,741, entitled “VALUE PROCESSING NETWORK AND METHODS,” filed on Jun. 11, 2003, by George Nauman, et al, the entire disclosure of each of which is herein incorporated by reference for all purposes.

### BACKGROUND OF THE INVENTION

The process for health care providers to verify a patient's insurance eligibility and to settle claims is ripe for improvement. Prior to providing care, providers contact payers to verify whether a patient is actually covered under a particular plan, what specific procedures, lab tests, and the like are covered under the plan, and whether dependents are covered. In most present cases, providers either type patient information into a web-based or batch-based system or call voice IVR (interactive voice response) systems to verify a patient's coverage. This process is costly, time consuming, and error prone, often resulting in delayed payment of claims due to eligibility issues.

Some have attempted to solve these problems by using current credit card technology (see, for example, previously-incorporated U.S. patent application Ser. No. 10/675929 (Attorney Docket No. 020375-032410)). Although successful in some cases, limitations on the amount of information such systems can return provide opportunities for additional improvement as taught herein.

Once care is provided, providers often file claims on behalf of patients and await payment from the coverage provider. If the patient paid a deductible, co-payment, or other payment, the patient also may complete claim forms and return them to a provider or third party administrator. Further, if the patient received a prescription from the doctor, the patient and/or a pharmacist also may complete claim forms for reimbursement for pharmaceuticals and/or over-the-counter medications, which, in some cases, are now reimbursable under flexible spending accounts (FSAs), health reimbursement accounts (HRAs) and/or other types of healthcare and stored value balances. Each of these processes is administratively intensive; collectively they become overwhelming for some individuals for even a single doctor visit. The present invention addresses these and other issues related to health care eligibility verification and settlement.

### BRIEF SUMMARY OF THE INVENTION

Embodiments of the invention thus provide a health care eligibility and settlement presentation instrument. The instrument includes an information encoding region from which information is readable by a point-of-sale device. The information encoding region has encoded therein one or more account designators that relate to at least two accounts, a first account being an eligibility account and a second account being a payment account. Transmission of a first account designator to a health care eligibility verification system initiates a process that results in the return of a health care eligibility verification packet to a provider. Transmission of a second account designator initiates a process that results in payment of services to the provider. The first and second account designators may be the same or may be different. The presentation instrument may be a plastic card, credit card, debit card, stored value card, private label card, bar coded card, smart cards, DDA payment (bank account direct debit) card, or the like. The process that results in payment of services to the provider may relate to a credit card settlement, a debit card settlement, a flexible spending account settlement, a health savings account settlement, health reimbursement account settlement, medical savings account settlement, transportation account settlement, parking settlement, dependent care settlement, a claim settlement or the like.

In other embodiments, a method of verifying health insurance coverage eligibility for a patient includes receiving at a host computer system a message from a provider. The message may be a request for an eligibility and coverage information packet and the message may identify at least the patient and the provider. The method, also includes using at least a portion of the information in the request to locate a payer associated with the patient and sending a message to a computing system of the payer. The message includes a request to return to the host computer system the eligibility and coverage information packet. The method also includes receiving the eligibility and coverage information packet from the computing system of the payer and sending the packet to the provider. Sending the packet to the provider may include sending the packet to the provider in a manner identified in the request from the provider. Sending the packet to the provider may include sending the packet to the provider according to a primary means pre-selected by the provider. Sending the packet to the provider may include sending the packet to the provider according to a secondary means pre-selected by the provider. Sending the packet to the provider may include sending the packet by facsimile, electronic message, Internet posting, IVR system, or the like.

In other embodiments, a system for verifying health insurance coverage eligibility for a patient includes a host computer system, means for communicating with providers and means for communicating with payers. The host computer system is programmed to receive a message from a provider. The message includes a request for an eligibility and coverage information packet and identifies at least the patient and the provider. The host computer system is further programmed to use at least a portion of the information in the request to locate a payer associated with the patient and send a message to a computing system of the payer. The message includes a request to return to the host computer system the eligibility and coverage information packet. The host computer system is further programmed to receive the eligibility and coverage information packet from the computing system of the payer and send the packet to the provider. The host computer system may be further programmed to send the packet to the provider in a manner identified in the request from the provider. The host computer system may be further programmed to send the packet to the provider according to a primary means pre-selected by the provider. The host computer system may be further programmed to send the packet to the provider according to a secondary means pre-selected by the provider. The host computer system may be further programmed to send the packet by facsimile, electronic message, Internet posting, IVR system, or the like.

In still other embodiments, a method of settling a transaction relating to health care includes receiving at a host computer system a transmission from a provider device. The transmission includes account identifier information from a member's health care benefits presentation instrument. The method also includes using the account information to locate multiple balances relating to the member and initially aggregating the balances and comparing a transaction to the resulting total. The method also includes further analyzing each balance independently and comparing each independent balance to the transaction total. The method also includes transmitting an approval code to the provider device based on the comparison. The method may include thereafter segmenting the transaction into at least two parts and processing the parts as two different settlement transactions. One of the parts may be a flexible spending account settlement transaction or a health care spending account settlement transaction and the other may be a debit card transaction, a credit card transaction, or a covered service claim settlement transaction.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1A illustrates a system according to embodiments of the present invention.

FIG. 1B illustrates a presentation instrument according to one or more embodiments of the invention that may be used in the system of FIG. 1A for health care eligibility verification and/or settlement.

FIG. 2 illustrates a method of verifying health insurance eligibility according to embodiments of the present invention, which may be implemented in the system of FIG. 1A.

FIG. 3 illustrates a method of enrolling members into a health insurance plan according to embodiment of the invention.

FIG. 4 illustrates a method of authorizing and settling payments for health care using the health insurance presentation instrument of FIG. 1B.

FIG. 5 illustrates a method of authorizing and settling pharmaceutical purchases using the health insurance presentation instrument of FIG. 1B.

DETAILED DESCRIPTION OF THE INVENTION

According to embodiments of the invention, a health care provider (sometimes referred to herein simply as “a provider”) starts the verification process of a patient's (also referred to herein as “member”) health insurance eligibility by reading information from a health insurance presentation instrument of the patient using a reader. Using this information, the provider sends a request for eligibility verification to a host computer system. Acting as an information clearing house, the host computer system consults stored information to determine to which of several payer (e.g., insurance company, third party administrator, self insured employer, or the like) systems the request should be forwarded. In response to the request from the host computer system, the appropriate payer system returns an eligibility and coverage information packet to the host computer system. The host computer system then forwards the packet to the provider.

In some embodiments, the host computer system forwards the packet in a manner pre-selected by the provider. In other embodiments, the packet is forwarded in a manner identified in the request from the provider. Such manners include fax, email, Internet, IVR, healthcare terminal, EDI, and the like.

Once care is provided, the same presentation instrument may be used to settle payments due for the care. This may include the provider receiving payment from the payer or a third party administrator for covered services and/or from funds held in an FSA, HRA, and/or other balances of the patient. Further, a pharmacist may be reimbursed in similar fashion. If the patient owes a deductible or co-payment for covered services, the same presentation instrument may access a line of credit which the patient may use for such purposes. Of course, patients may settle accounts for visits to a dentist or other heath care-related provider in similar fashion. Thus, an employer may advantageously provide its employees the opportunity to access many different types of health care balances using a single presentation instrument, the systems and methods for doing so being described in more detail hereinafter.

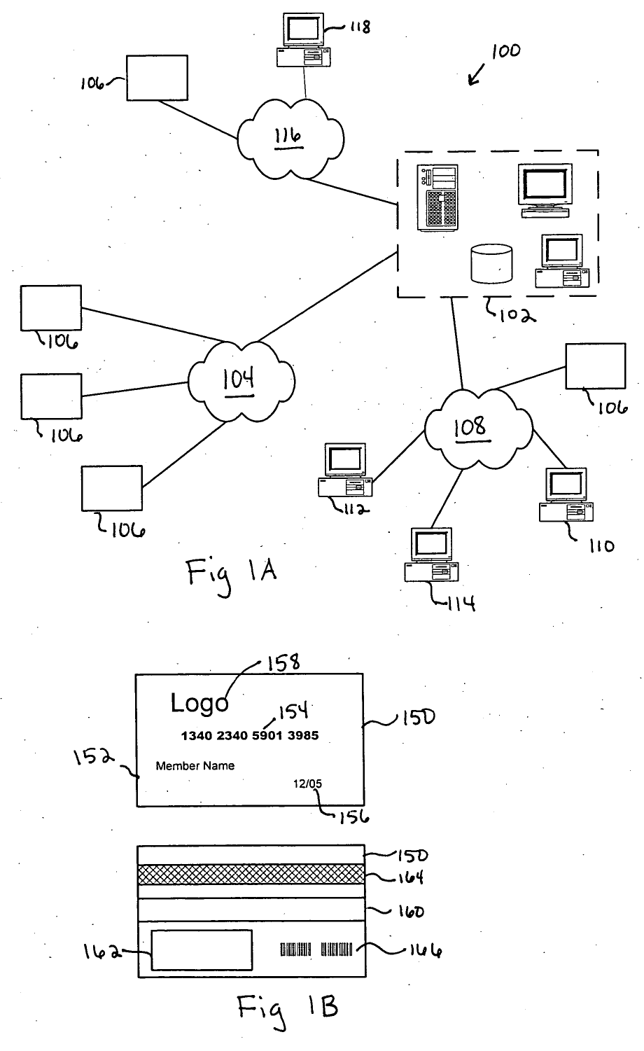

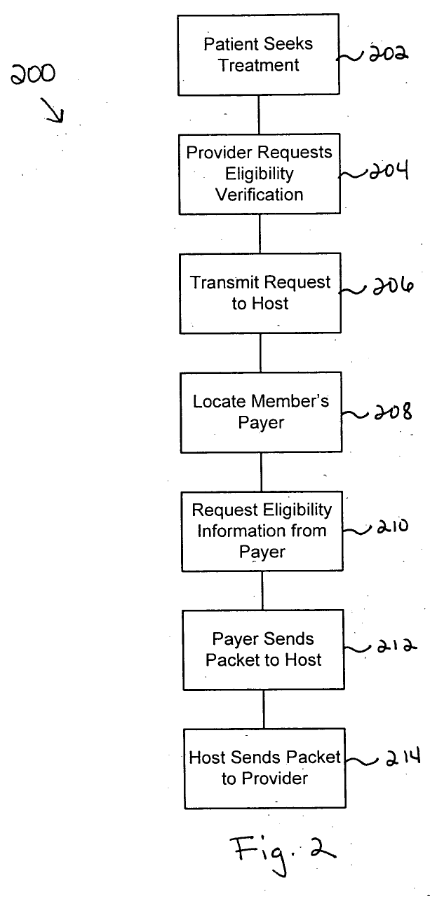

Having described the present invention generally, attention is directed to FIG. 1A, which illustrates one exemplary embodiment of a system 100 according to the present invention. As will be explained in more detail hereinafter, the system 100 may be used to verify insurance coverage, process insurance claims, pay claims, and/or the like. It should be understood that the examples used herein relate to medical insurance. However, this is not a requirement. Other types of insurance and prepaid services may benefit from the teachings herein, as is apparent to those skilled in the art in light of this disclosure.

The system 100 includes a host computer system 102. The host computer system 102 may include, for example, a server computer, a personal computer, a workstation, or other suitable computing device. The host computer system 102 includes application software that programs the host computer system 102 to perform one or more functions according to the present invention. For example, application software resident on the host computer system 102 may program the host computer system 102 to receive and process credit card transaction information. The host computer system 102 may include one or more of the aforementioned computing-devices, as well as storage devices such as databases, disk drives, optical drives, and the like. The host computer system 102 may be fully located within a single facility or distributed geographically, in which case a network may be used to integrate the host computer system 102. Many other examples are possible and apparent to those skilled in the art in light of this disclosure. Thus, this example of a system 100 according to the present invention is not to be considered limiting.

The system 100 also includes a first communication network 104. The first network 104 may be the Internet, an intranet, a wide area network (WAN), a local area network (LAN), a virtual private network, and combination of the foregoing, or the like. The network 104 may include both wired and wireless connections, including optical links. In some embodiments, the network 104 is a settlement network, such as a credit card transaction processing network. In some embodiments, however, eligibility may be verified through the first network. Through the network 104, provider devices 106 communicate with the host computer system 102.

The provider devices 106 may be any device capable of reading information from health insurance presentation instruments and transmitting the information through a communication link, such as the network 104, to a processing system, such as the host computer system 102. The information may be comprised by a request for eligibility verification and/or a transaction settlement message. In some embodiments, the provider devices 106 comprises a reader, such as a mag stripe reader, a smart chip reader, a bar code reader, or the like, in combination with a computing device. In some embodiments, the provider devices 106 comprise point-of-sale devices such as those more fully described in co-pending, commonly assigned U.S. patent app. Ser. No. 10/116,689, entitled “SYSTEMS AND METHODS FOR PERFORMING TRANSACTIONS AT A POINT-OF-SALE,” filed Apr. 3, 2002, by Earney Stoutenburg, et al., which is a continuation-in-part of U.S. patent app. Ser. No. 09/634,901, entitled “POINT OF SALE PAYMENT SYSTEM,” filed Aug. 9, 2000, by Randy J. Templeton, et al., which is a non-provisional of U.S. Prov. App. No. 60/147,899, entitled “INTEGRATED POINT OF SALE DEVICE,” filed Aug. 9, 1999 by Randy Templeton, et al., the entire disclosures of which are herein incorporated by reference for all purposes. In still other embodiments, the provider devices 106 comprise specially-designed computing and reading devices for reading information from a patient's insurance card, constructing a request for an eligibility and coverage information packet, and transmitting the request to the host computer system. Those skilled in the art will recognize equivalent devices in light of this disclosure. In some embodiments, the provider devices 106 are capable of receiving eligibility and coverage information packets and displaying the information to a user.

The provider devices 106 may be located at any of a wide variety of provider locations. By way of example and not limitation, these locations include doctor's offices, dentist's offices, pharmacies, hospitals, drug stores, chiropractor's offices, physical therapists, and the like. Provider devices 106 also may communicate with the host computer system 102 through a second network 108.

The system 100 also includes a second network 108, which may be any of the aforementioned networks. The first network 104 and the second network 108 may be the same network, different networks, or portions of a larger network. The second network 108 provides a connection between the host computer system 102 and payer computing systems 110, among other things.

The payer computing systems 110 may be any computing system that provides access to data. Associated storage devices may include solid state memory, such as RAM, ROM, PROM, and the like, magnetic memory, such as disc drives, tape storage, and the like, and/or optical memory, such as DVD. The payer computing systems 110 may be co-located with the host computer system 102, may be integral with the host computer system 102, or may be located apart from the host computer system 102.

The system 100 also may include member computing systems 112 and third party administrator computing systems 114, each of which may be any of the aforementioned computing system types. Members may view information relating to their benefits by accessing the host computing system 102, while payers (e.g., insurance company, third party administrator, self insured employer, or the like) may send and receive information necessary to process claims and settle FSA, HSA and other healthcare and stored value balances on behalf of payers and members.

In some embodiments, the system 100 also includes a specialty network 116, which, in a specific embodiment is a pharmacy network. The specialty network may be any of the aforementioned network types. Through the specialty network 116, certain providers 106 (e.g., pharmacists, drug stores, cash register system providers, and the like) may interact with the host computer system to settle claims for certain covered items such as prescription drugs and IRS approved OTC items. In some embodiments, a specialty services administrator 118 (e.g., a pharmacy benefits administrator, cash register system provider) is also tied into this network and involved in the process as will be explained further below.

FIG. 1B illustrates an embodiment of a health care presentation instrument 150 according to an embodiment of the invention. The presentation instrument is used to identify the member (i.e., patient, employee, or covered individual) to providers, and provide information to the provider device 106 used to verify eligibility and/or settle claims. In this embodiment, the presentation instrument comprises what consumers commonly recognize as a credit card or debit card. One side of the card is embossed with the member's name 152, an account number 154, expiration date 156, and the like. The card may have a logo 158 of the payer. Additionally, the card may have other recognizable features that identify it as a branded credit card.

The back side of the card may include a signature line 160, and plan information 162. Plan information may include a group number, a plan administrator phone number, and other similar information. In some embodiments, information such as deductibles, co-payments, specific pharmacy data, and the like is included. In other embodiments, this type information is intentionally omitted to improve flexibility by allowing such information to be changed without necessitating card reissuance.

The card also includes one or more information encoding features. Information encoding features may include a magnetic stripe 164, a bar code 166, a smart chip (not shown), and the like. It is to be understood that many other examples of a health care presentation instrument and associated information encoding features are possible.

Attention is directed to FIG. 2, which illustrates a method 200 of verifying medical insurance coverage according to embodiments of the present invention. The method may be implemented in the system 100 described above with reference to FIG. 1A. At block 202, a patient seeks treatment from a provider. In doing so, the patient presents the provider with a medical insurance presentation instrument, which may be a card, such as a credit or debit card. The card is pre-encoded with information that minimally identifies the patient. The card may be encoded in any of a number of well know ways. For example, the card may contain a magnetic stripe, a smart chip, a bar code, and/or the like.

At block 204, the provider initiates a request for eligibility verification. Doing so may comprise interfacing the patient's presentation instrument to the provider device 106. In a specific embodiment, this comprises swiping a card with a magnetic strip card through a magnetic stripe reader or reading a chip through a smart card reader. Those skilled in the art will recognize a number of equivalent methods to accomplish the same end. The request also includes information that identifies the provider.

At block 206, the request is transmitted to the host computer system 102 via the network 104.

At the host computer system 102, the request is used to locate a payer (e.g., an insurance provider) relating to the patient. This takes place at block 208. Locating the payer may comprise, for example, consulting a database or lookup table that identifies the payer based on the patient. In some cases, the payer may be different based on the provider.

At block 210, the host computer system routes a message to the payer requesting an eligibility coverage and information packet for the patient. Upon receipt of the message, the payer returns the requested packet at block 212.

The host computer system 102 routes the eligibility and coverage information packet to the provider at block 214. In some embodiments, this comprises sending the packet to the provider in an electronic message (e.g., email, POS device, etc.). In other embodiments, this comprises faxing the packet to the provider. In still other embodiments, this comprises sending the information to the provider by way of an IVR. Many other examples are possible, including making the packet available for download via a web site, sending the packet to a point-of-care (POC) terminal at the provider's location, and/or the like.

The packet may be sent to the provider according to the provider's instructions. In some embodiments the provider pre-defines primary, secondary, and possibly even tertiary methods for routing packets to the provider. In some embodiments, the provider may define the method by which the provider desires to receive the packet in the original request for eligibility verification.

The content of the eligibility and coverage information packet may vary. In some examples the content includes simply a verification of coverage. In other examples, however, the content includes the patient's deductibles and progress toward satisfying his deductibles, his co-payments, his health care spending account balances, and the like. This information may be used to initiate—and in-some cases even complete—payment of claims as will be described in more detail below.

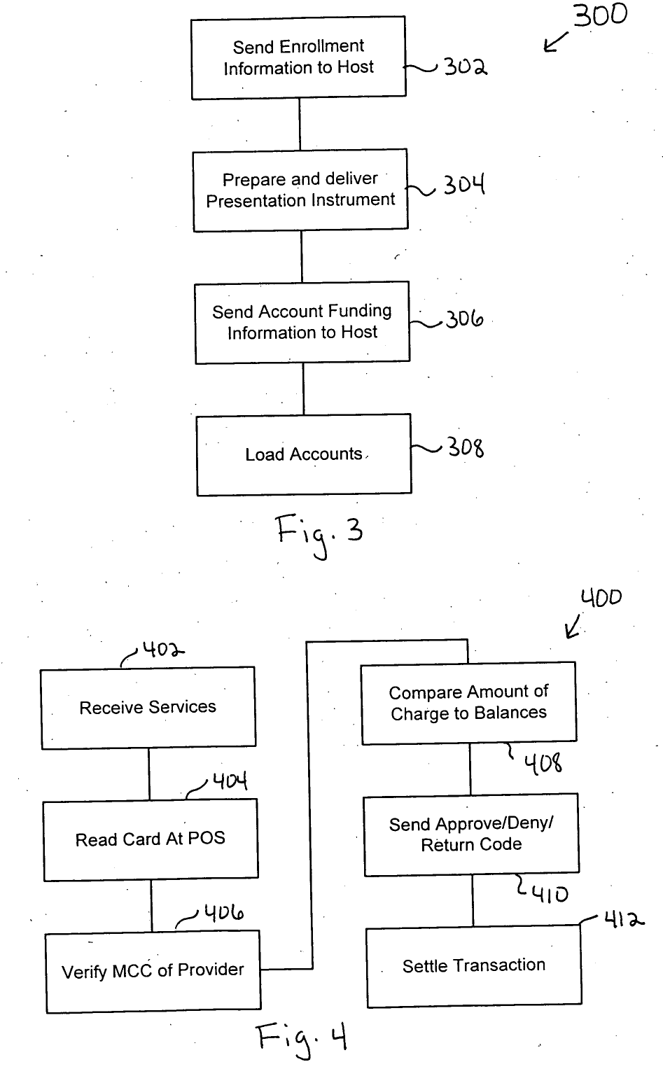

Attention is directed to FIG. 3 which illustrates a method 300 for enrolling members into a plan. The method may be implemented in the system of FIG. 1A. It should be noted that this method is merely exemplary, and other methods according to embodiments of the invention may include more, fewer, or different steps, as is apparent to those skilled in the art in light of this disclosure. The method begins at block 302 when a payer, using a payer computing system 110, sends enrollment information to the host computing system 102. The enrollment information includes enrollment information for one or more members and includes such items as the benefits for which the member has enrolled, whether the member has requested a debit or credit account to which to charge deductibles, co-payments, non-covered health-related expenses, and the like.

At block 304, the host computing system 102 prepares a health care presentation instrument for each member. In a specific embodiment, this comprises embossing plastic such as is commonly used for credit and debit cards and encoding information into an information encoding feature such as a magnetic stripe 164, printing plan information on the card and the like. Presentation instruments are then sent to members along with other plan information.

At block 306, the payer sends additional information such as the amount the member has elected to contribute to a FSA and/or HSA, and the like, if this information was not previously provided. The payer also supplies information such as which Merchant Category Codes (MCCs) are authorized for charges and maximum transaction amounts, etc. for eligible charges for each balance established on the presentation instrument. Thus, for example, a member could use his presentation instrument at doctor and dentist offices but not retail stores and gas stations.

At block 308, the host computing system then establishes a balance for each category elected for a member and associates the balance with the member's presentation instrument. Thus, when the member uses the presentation instrument to access health care, the same presentation instrument may be used to settle any or all cost categories (i.e., deductible, co-payment, non-covered expense, and the like).

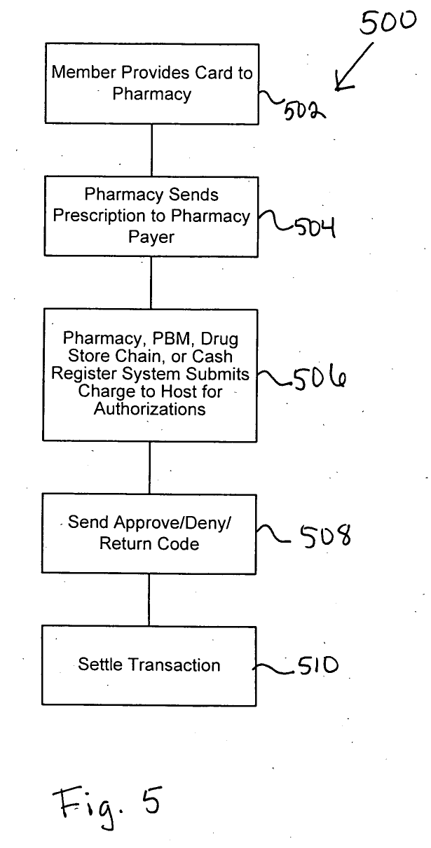

Having-described the process for enrolling members, attention is directed to FIG. 4, which illustrates a method 400 by which a provider receives authorization and payment for health care service rendered to a member. As with the previous methods, this method is merely exemplary and other embodiments may include more, fewer, or different steps, and the steps may occur in different orders. The method 400 may be implemented in the system 100 of FIG. 1. The methods begins at block 402 when the member receives service from a provider. Either before or after the member receives service, the provider initiates payment by reading the member's presentation instrument 150 using, for example a provider device 106. This takes place at block 404. The member's card information is transmitted to the host computer system 102. The host computer system 102 then verifies the MCC of the provider to determine that the presentation instrument 150 is valid for charges at that particular provider. This takes place at block 406. Additionally, at block 408 the host computer system 102 compares the amount of the charge to one or more fund balances of the member. In some examples, multiple balances of the member are aggregated to determine an approval threshold or each balance type can be evaluated separately. Based on the comparison, the host computer system sends an approval, a denial, or a return code at block 410. Assuming the transaction was approved, the transaction is then settled at block 412.

In some embodiments, transactions settlement comprises segmenting the transaction in to multiple portions. For example, one portion of the amount may be paid from a payer as a covered expense, and another portion of the amount, which also may be paid by the payer, may come from the member's FSA, HSA, or other predefined balance. Yet another portion of the amount may represent a deductible or co-payment and ultimately come from the member. The member may, however, use the presentation instrument to charge the amount and be billed thereafter. Thus, the various portions may traverse various financial processing networks separately.

Attention is now directed to FIG. 5, which illustrates yet another embodiment of the invention, this one being a method 500 of approving and settling a transaction for pharmaceuticals. Although much like approving and settling transactions relating to health care, subtle differences exist. At block 502, the member provides his presentation instrument to the pharmacy and the attendant reads the presentation instrument using an existing pharmacy device, which may be a provider device 106. If the purchase involves a prescription, then the member also provides their presentation instrument to the attendant, and the attendant sends the prescription information to a pharmacy payer or third party administrator 118 via the pharmacy network 116. This takes place at block 504. The pharmacy transmits appropriate information from the member's presentation instrument and/or the pharmacy payer to the host computer system 102 at block 506. The host computer system 102 performs appropriate comparisons to approve or deny the charge authorization at block 508. This may include checking the pharmacy's MCC, comparing the amount of the transaction to the member's balances, and the like. The transaction is settled at block 510, which may include settlement procedures similar to those discussed above with respect to block 412.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to arrange computers into a network and enable communication among the computers. Additionally, those skilled in the art will realize that the present invention is not limited to verifying health insurance coverage and settling associated claims. For example, the present invention may be used by rental car agencies to verify automobile insurance for customers, and the like. Accordingly, the above description should not be taken as limiting the scope of the invention, which is defined in the following claims.

1. A health care eligibility and settlement presentation instrument, comprising:
an information encoding region from which information is readable by a point-of-sale device, the information encoding region having encoded therein one or more account designators that relate to at least two accounts, a first account being an eligibility account and a second account being a payment account, wherein transmission of a first account designator to a health care eligibility verification system initiates a process that results in the return of a health care eligibility verification packet to a provider, and wherein transmission of a second account designator initiates a process that results in payment of services to the provider.

2. The health care eligibility and settlement presentation instrument of claim 1, wherein the first and second account designators are the same.

3. The health care eligibility and settlement presentation instrument of claim 1, wherein the first and second account designators are different.

4. The health care eligibility and settlement presentation instrument of claim 1, wherein the presentation instrument comprises a selection from the group consisting of plastic card, credit card, debit card, stored value card, private label card, bar coded card, smart cards, and DDA payment (bank account direct debit) card.

5. The health care eligibility and settlement presentation instrument of claim 1, wherein the process that results in payment of services to the provider relates to a selection from the group consisting of a credit card settlement, a debit card settlement, a flexible spending account settlement, a health savings account settlement, health reimbursement account settlement, medical savings account settlement, transportation account settlement, parking settlement, dependent care settlement and a claim settlement.

6. A method of verifying health insurance coverage eligibility for a patient, comprising:
receiving at a host computer system a message from a provider, wherein the message comprises a request for an eligibility and coverage information packet and wherein the message identifies at least the patient and the provider;
using at least a portion of the information in the request to locate a payer associated with the patient;
sending a message to a computing system of the payer, wherein the message comprises a request to return to the host computer system the eligibility and coverage information packet;
receiving the eligibility and coverage information packet from the computing system of the payer; and
sending the packet to the provider.

7. The method of claim 6, wherein sending the packet to the provider comprises sending the packet to the provider in a manner identified in the request from the provider.

8. The method of claim 6, wherein sending the packet to the provider comprises sending the packet to the provider according to a primary means pre-selected by the provider.

9. The method of claim 6, wherein sending the packet to the provider comprises sending the packet to the provider according to a secondary means pre-selected by the provider.

10. The method of claim 6, wherein sending the packet to the provider comprises sending the packet by a means selected from the group consisting of facsimile, electronic message, Internet posting, and IVR system.

11. A system for verifying health insurance coverage eligibility for a patient, comprising:
a host computer system;
means for communicating with providers; and
means for communicating with payers;
wherein the host computer system is programmed to:
receive a message from a provider, wherein the message comprises a request for an eligibility and coverage information packet and wherein the message identifies at least the patient and the provider;
use at least a portion of the information in the request to locate a payer associated with the patient;
send a message to a computing system of the payer, wherein the message comprises a request to return to the host computer system the eligibility and coverage information packet;
receive the eligibility and coverage information packet from the computing system of the payer; and
send the packet to the provider.

12. The system of claim 11, wherein the host computer system is further programmed to send the packet to the provider in a manner identified in the request from the provider.

13. The system of claim 11, wherein the host computer system is further programmed to send the packet to the provider according to a primary means pre-selected by the provider.

14. The system of claim 11, wherein the host computer system is further programmed to send the packet to the provider according to a secondary means pre-selected by the provider.

15. The system of claim 11, wherein the host computer system is further programmed to send the packet by a means selected from the group consisting of facsimile, electronic message, Internet posting, and IVR system.

16. A method of settling a transaction relating to health care, comprising:
receiving at a host computer system a transmission from a provider device, wherein the transmission comprises account identifier information from a member's health care benefits presentation instrument;
using the account information to locate multiple balances relating to the member;
initially aggregating the balances and comparing a transaction to the resulting total;
further analyzing each balance independently and comparing each independent balance to the transaction total; and
transmitting an approval code to the provider device based on the comparison.

17. The method of claim 16, further comprising:
thereafter segmenting the transaction into at least two parts and processing the parts as two different settlement transactions.

18. The method of claim 17, wherein one of the parts comprises a selection from the group consisting of flexible spending account settlement transaction and health care spending account settlement transaction and the other comprises a selection from the group consisting of debit card transaction, credit card transaction, and covered service claim settlement transaction.
